(19) United States
(12) Patent Application Publication
(10) Pub. No.: US 2024/0075553 A1
(43) Pub. Date: Mar. 7, 2024

(54) REGULATING AIR FLOW TO IMPROVE LASER WELD QUALITY

(71) Applicant: GM GLOBAL TECHNOLOGY OPERATIONS LLC, DETROIT, MI (US)

(72) Inventors: Wei Zeng, Oakland Township, MI (US); Scott E. Parrish, Farmington Hills, MI (US); Baixuan Yang, Canton, MI (US); Hui-ping Wang, Troy, MI (US); Scott A. Hooker, Sterling Hts, MI (US); Blair E. Carlson, Ann Arbor, MI (US)

(21) Appl. No.: 17/901,158

(22) Filed: Sep. 1, 2022

(51) Int. Cl. B23K 26/14; B23K 26/03

(52) U.S. Cl. CPC B23K 26/14; B23K 26/032

(57) ABSTRACT

Aspects of the disclosure include air flow systems configured to regulate air flow when laser welding to improve laser weld quality. An exemplary air flow system can include a primary inlet coupled to an air source and one or more secondary inlets coupled to the primary inlet. At least one of the one or more secondary inlets can include an internal valve. Each internal valve is actuatable between a fully open state, a fully closed state, and an intermediate state. The air flow system can further include an outlet coupled to each of the one or more secondary inlets downstream of the internal valve and a controller configured to adjust a position of each internal valve. The controller is configured to adjust the position of each internal valve based on an air flow mapping to increase an average air flow velocity along a laser beam of a welding laser.

### INTRODUCTION

The subject disclosure relates to laser welding, and particularly to regulating air flow when welding to improve laser weld quality.

Laser welding technologies are increasingly used in a range of manufacturing sectors such as the aero-space industry and automotive industry to take advantage of the high quality, high accuracy, and high speed welds offered by laser welding systems. When laser welding, a plasma-plume with micro size metal particles can be produced at the surface of the work piece irradiated by the laser beam. For example, when irradiating a steel sheet coated with an anti-corrosive agent (e.g., Zn), the coating and the base material can be vaporized and plasmarized to produce an ion. These ions then cool, forming a particulate that often floats in air. The resultant particulate can be relatively thick, forming a cloud-like region over the work piece that blocks some or all of the laser beam. The weld plume weakens the laser light projection to the work piece due to absorption, refraction, and scattering effects. Ideally, the weld plume would be rapidly removed, since it destabilizes the amount of heat that the laser beam applies to the work piece.

### SUMMARY

In one exemplary embodiment an air flow system for welding applications includes a primary inlet coupled to an air source and one or more secondary inlets coupled to the primary inlet. In some embodiments, at least one of the one or more secondary inlets includes an internal valve. Each internal valve is actuatable between a fully open state, a fully closed state, and an intermediate state. The air flow system can further include an outlet coupled to each of the one or more secondary inlets downstream of the internal valve and a controller configured to adjust a position of each internal valve. In some embodiments, the controller is configured to adjust the position of each internal valve based on an air flow mapping to increase an average air flow velocity at a beam spot of a welding laser.

In some embodiments, the air flow system comprises two secondary inlets coupled to the primary inlet via a splitter. In some embodiments, an internal valve is positioned in the splitter.

In some embodiments, each of the one or more secondary inlets includes an internal valve.

In some embodiments, the air flow system further includes an air monitoring system. In some embodiments, the air monitoring system includes a particle image velocimetry (PIV) system configured to generate the air flow mapping.

In some embodiments, the controller is configured to adjust a position of each internal valve based in part on a weld plume observation.

In some embodiments, the air flow system further includes a weld beam adjuster coupled to the welding laser. In some embodiments, the weld beam adjuster is configured to adjust an angle of a laser beam terminating at the beam spot of the welding laser. In some embodiments, the controller is further configured to adjust, via the weld beam adjuster, the angle of the laser beam based on the air flow mapping to increase an average air flow velocity along the laser beam.

In another exemplary embodiment, a method includes providing an air flow system. The air flow system can include a primary inlet coupled to an air source and one or more secondary inlets coupled to the primary inlet. At least one of the one or more secondary inlets includes an internal valve and each internal valve is actuatable between a fully open state, a fully closed state, and an intermediate state. The air flow system can further include an outlet coupled to each of the one or more secondary inlets downstream of the internal valve and a controller configured to adjust a position of each internal valve. The method can include generating an air flow mapping and adjusting, via the controller, the position of each internal valve based on the air flow mapping to increase an average air flow velocity at a beam spot of a welding laser.

In some embodiments, the method further includes adjusting, via the controller, a position of each internal valve based in part on a weld plume observation.

In some embodiments, the air flow system further includes a weld beam adjuster coupled to the welding laser. In some embodiments, the method further includes adjusting, via the weld beam adjuster, an angle of a laser beam terminating at the beam spot of the welding laser. In some embodiments, the controller is further configured to direct the weld beam adjuster to adjust the angle of the laser beam based on the air flow mapping to increase an average air flow velocity along the laser beam.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 depicts a perspective view of an air flow system for regulating air flow when welding to improve weld quality according to one or more embodiments;

FIG. 2 depicts a block diagram of valve control logic for an air flow system configured in accordance with one or more embodiments;

FIG. 3 depicts a schematic block diagram of another embodiment of the air flow system of FIG. 1 in accordance with one or more embodiments;

FIG. 4A depicts a horizontal air flow mapping for an air flow system configured in accordance with one or more embodiments;

FIG. 4B depicts the horizontal air flow mapping of FIG. 4A after adjusting one or more internal valves of the air flow system in accordance with one or more embodiments;

FIG. 4C depicts a legend for the horizontal air flow mappings of FIGS. 4A and 4B in accordance with one or more embodiments;

FIG. 5A depicts a vertical air flow mapping for an air flow system configured in accordance with one or more embodiments;

FIG. 5B depicts a vertical air flow mapping for an air flow system when space or fixturing is limited in accordance with one or more embodiments;

FIG. 5C depicts a legend for the vertical air flow mappings of FIGS. 5A and 5B in accordance with one or more embodiments;

FIG. 6A depicts a cross-sectional view of a portion of an air flow system in accordance with one or more embodiments;

FIG. 6B depicts a cross-sectional view of a portion of an air flow system in accordance with one or more embodiments;

FIG. 7 is a computer system according to one or more embodiments; and

FIG. 8 is a flowchart in accordance with one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

Laser welding platforms are highly desired, offering high quality, high accuracy, and high speed welds that are compatible with a wide range of materials. Laser welding applications are highly susceptible to weld plumes, reducing welding efficiency and weld quality. Some laser welding applications have integrated an airflow device, such as a fan or blower, with or within the laser welding system to deliver a continuous flow of air to the surface of the work piece. The air generated by the airflow device is positioned to remove or mitigate the weld plume in the path of the laser beam.

Challenges remain, however, in regulating the supply of air delivered to the work piece. For example, some airflow devices can provide a continuous, large volume of air, but cannot modulate the flow velocity across the work piece. In other words, some airflow devices create a gradient of air flow proximate the work piece. In some cases, the air flow velocity varies widely laterally (along the surface of the work piece), perpendicularly (between the work piece and the laser), or both laterally and perpendicularly. Air flow gradients can even result in dead zones, or regions of relatively little air flow. For example, the center of a vortex can have little air velocity even when the vortex edge itself has a relatively high air velocity. Air flow gradients can lead to poor weld plume control, and consequently, poor weld quality and lower welding efficiency.

This disclosure introduces an active system to effectively regulate air flow to a work piece when laser welding. Advantageously, aspects of the disclosure can adjust individual air flows within an air flow system to achieve air flow distributions (air flow gradients) that facilitate a desired weld quality. In some embodiments, air flow regulation is guided by an air flow mapping to ensure quality welds. Actively managing air flow gradients in this manner allows an air flow system to maintain a low, steady weld plume throughout the welding process, improving weld quality and welding efficiency. In some embodiments, an air flow map is analyzed to determine the air flow velocity at the weld spot. In some embodiments, the weld location (e.g., laser weld angle) can be adjusted to target a region (e.g., an air column) of higher air flow in the air flow map.

Although aspects of the disclosure are described in the context of a laser welding process, it should be readily understood that the welding air flow solutions described herein can be applied to any welding application where weld plume control is desired. All such applications are within the contemplated scope of this disclosure.

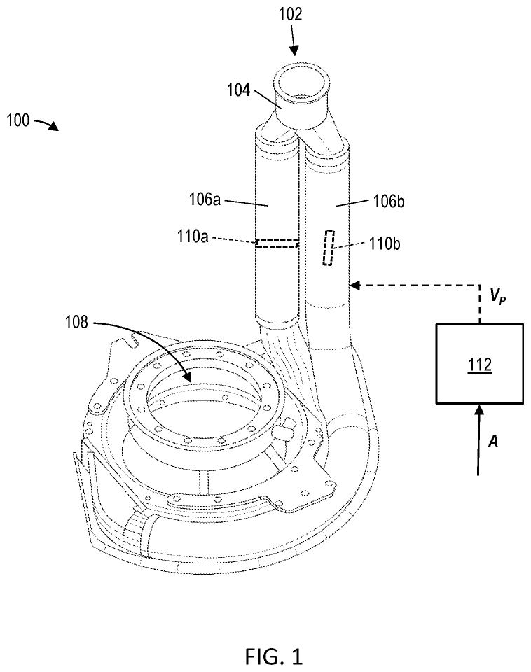

FIG. 1 illustrates a perspective view of an air flow system 100 for regulating air flow when welding to improve weld quality according to one or more embodiments. As shown in FIG. 1, the air flow system 100 can include a primary inlet 102, a splitter 104, and two or more secondary inlets (as shown, the two secondary inlets 106a, 106b), and an outlet 108. Although shown as having two secondary inlets 106a, 106b for ease of illustration and discussion, it should be understood that the number of secondary inlets in a specific application is not meant to be particularly limited. In some embodiments, for example, the air flow system 100 can include 2, 3, 4, 5, 6, 7, 8, 9, 10, 20, 50, 100, etc. secondary inlets. Moreover, in some embodiments, the splitter 104 is omitted (i.e., only a single inlet is possible). The primary inlet 102 can be coupled to an air source (not separately shown). The air source can be pressurized (i.e., above atmospheric pressure).

As further shown in FIG. 1, the air flow system 100 also includes, for each secondary inlet 106a, 106b, an internal valve (as shown, the two internal valves 110a, 110b for the secondary inlets 106a, 106b, respectively). In some embodiments, each of the internal valves 110a, 110b can be individually actuated (or otherwise positioned) within the secondary inlets 106a, 106b to control air flow through the secondary inlets 106a, 106b. In some embodiments, each of the internal valves 110a, 110b can be opened or closed to any degree (i.e., between and including a fully open and a fully closed state) to finely tune the air flow through the secondary inlets 106a, 106b. Advantageously, the internal valves 110a, 110b can be opened or closed to different degrees. For example, the internal valve 110a can be fully closed while the internal valve 110b can be fully open (as shown). In another example, the internal valve 110a can be 45 percent open while the internal valve 110b can be 70 percent open (or fully closed, or 20 percent open, etc., not separately shown).

The secondary inlets 106a, 106b are coupled to the outlet 108, through which the air flowing through the air flow system 100 exits. In some embodiments, the outlet 108 recombines the air flow from the secondary inlets 106a, 106b prior to discharge. In some embodiments, the outlet 108 discharges the air flow from the secondary inlets 106a, 106b at separate locations along the outlet 108. In some embodiments, the outlet 108 discharges a portion of the air flow from the secondary inlets 106a, 106b at separate locations along the outlet 108 and recombines a remaining portion of the air flow prior to discharge. It should be understood that all such configurations are within the contemplated scope of the disclosure.

In some embodiments, air flow system 100 includes a controller 112 (valve or air flow controller). In some embodiments, the controller 112 is communicatively coupled to a welding system (e.g., a laser welding system, not separately illustrated). In some embodiments, a current welding location can be provided as a signal (“A” in FIG. 1) from the welding system to the controller 112. In some embodiments, the controller 112 includes or is communicatively coupled to an air flow monitor (not separately shown) configured to map the air flow from the outlet 108. The air flow monitor is not meant to be particularly limited, but can include, for example, a particle image velocimetry (PIV) system. PIV systems can be used to optically obtain instantaneous or near-instantaneous velocity measurements and related properties in fluids. The fluid (e.g., air, although other fluids are possible) is seeded with tracer particles which, for sufficiently small particles, are assumed to faithfully follow the present flow dynamics. The fluid with entrained particles is illuminated so that the particles are visible and the motion of these particles is tracked and aggregated to generate a velocity field (air flow gradient) for the flow being studied. Other techniques used to measure flows include laser Doppler velocimetry and hot-wire anemometry, and all such techniques are within the contemplated scope of this disclosure.

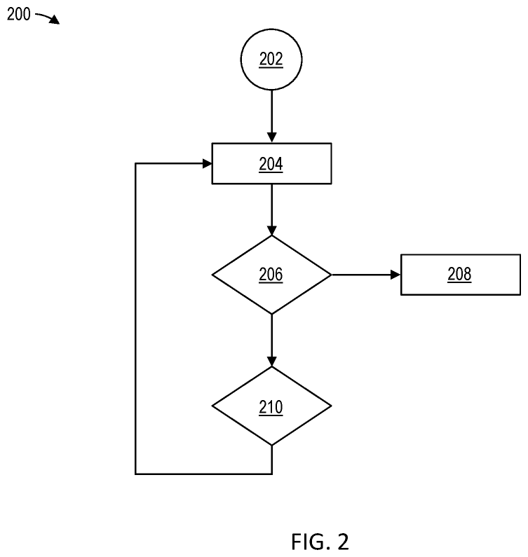

In some embodiments, the controller 112 is configured with valve control logic (see, e.g., FIG. 2). In some embodiments, the controller 112 is configured to adjust a position of one or more valves (e.g., one or both of the internal valves 110a, 110b) based on the signal “A”, the valve control logic, and/or an air flow mapping. The valve control logic is discussed in greater detail with respect to FIG. 2. In some embodiments, the controller 112 is configured to send a valve control signal (“VP” in FIG. 1) to the air flow system 100. The valve control signal can be used to actuate (or otherwise adjust) one or more of the internal valves 110a, 110b.

FIG. 2 depicts a block diagram of valve control logic 200 for an air flow system 100 configured in accordance with one or more embodiments. In some embodiments, a controller (e.g., the controller 112 of FIG. 1) is configured to evaluate the valve control logic 200 to maintain a target air flow velocity and/or gradient during a welding operation (e.g., a laser welding of a work piece).

At block 202, the initial valve positions for the internal valves 110a, 110b are determined. In some embodiments, the initial valve positions are set based on expected air flow conditions for the present welding operation. In some embodiments, expected air flow conditions (and respective valve positions) can be retrieved from saved calibration data. The saved calibration data can include, for example, actual air flow conditions and valve positions for one or more prior welding operations.

At block 204, the present welding operation begins with the internal valves 110a, 110b at their respective initial positions. As discussed previously, the welding operation can result in the formation of a weld plume.

At block 206, weld quality is evaluated. Weld quality can be evaluated using a range of parameters, such as, for example, a number of defects in or near the weld, a penetration depth of the weld, weld uniformity, etc. The precise method used to evaluate weld quality in a given application is not meant to be particularly limited. If the weld quality is good, the valve control logic 200 proceeds to block 208. If the weld quality is poor, the valve control logic 200 proceeds to block 210. In some embodiments, a weld is “good” if the weld parameters satisfy one or more predetermined conditions. For example, a weld can be “good” if the number of defects, the penetration depth, and/or the weld uniformity satisfies respective predetermined thresholds. Conversely, a weld is “poor” if the weld parameters do not satisfy one or more predetermined conditions.

At block 208 the current air flow settings (e.g., the current positions of the internal valves 110a, 110b and/or the current air flow conditions) are saved for future reference. In some embodiments, the current air flow settings are stored as saved calibration data, as discussed previously.

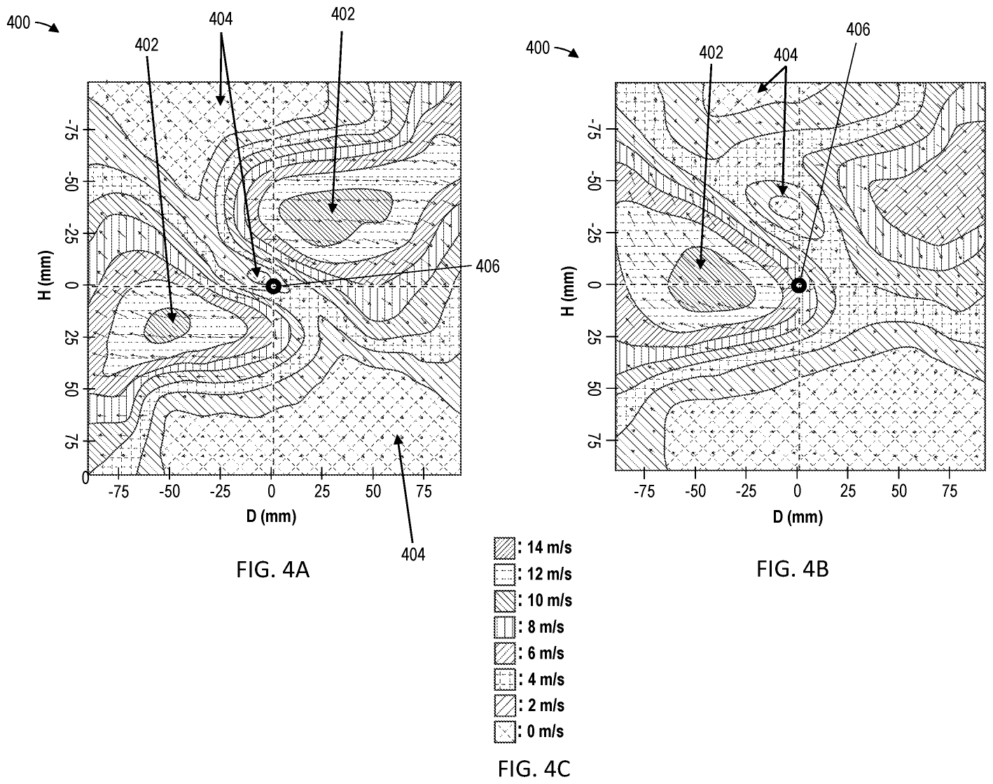

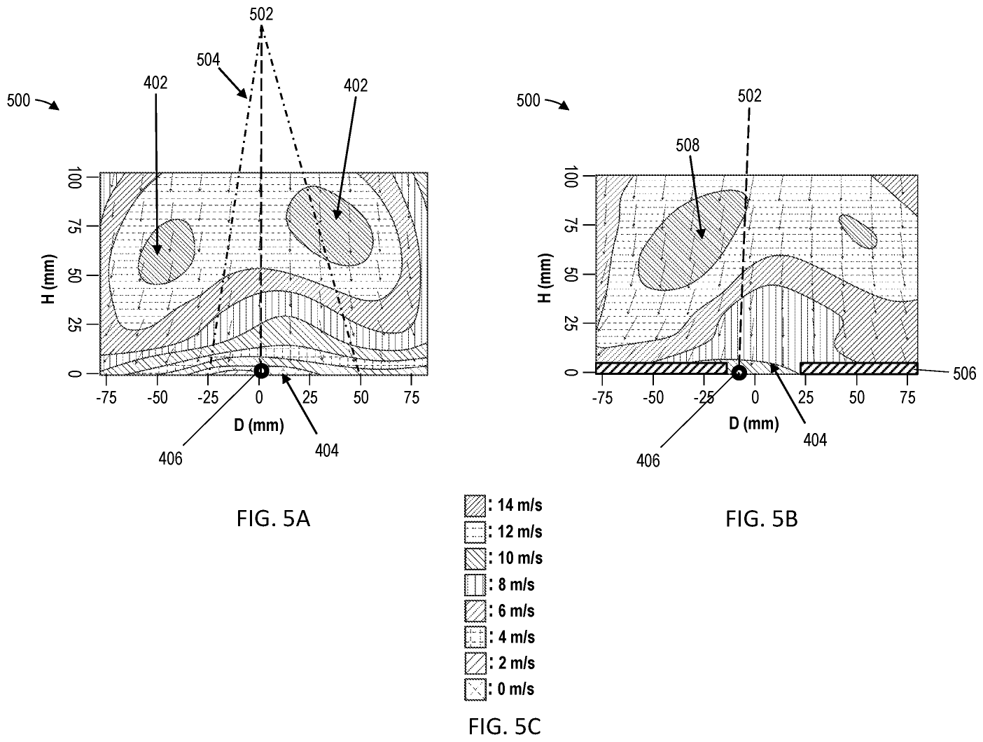

At block 210, the air flow is regulated by adjusting the positions of the internal valves 110a, 110b to improve the welding conditions. In some embodiments, air flow is regulated to control the weld plume. If the weld plume is high, the air flow rate and direction above the weld can be adjusted. For example, the current positions of the internal valves 110a, 110b can be adjusted to increase air flow at or above the weld spot based on an air flow velocity mapping of the welding operation. Air flow velocity mappings are discussed in greater detail with respect to FIGS. 4A, 4B, 5A, and 5B. If the weld plume is low, but wavering, the air flow rate can be reduced and/or the current positions of the internal valves 110a, 110b can be adjusted to stabilized air flow at or above the weld spot. After the positions of the internal valves 110a, 110b are adjusted the valve control logic 200 returns to block 204 and welding continues using the new calibration settings (e.g., valve positions).

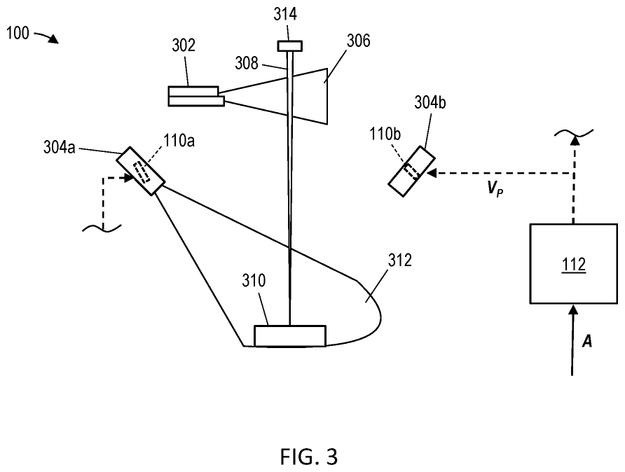

FIG. 3 illustrates a schematic block diagram of another embodiment of the air flow system 100. As shown in FIG. 3, the air flow system 100 can include an air knife 302 and two or more external flow inlets (as shown, the two external flow inlets 304a, 304b). Although shown as having a single air knife 302 and two external flow inlets 304a, 304b for ease of illustration and discussion, it should be understood that the number of air knives and external flow inlets in a specific application is not meant to be particularly limited. In some embodiments, for example, the air flow system 100 includes 2, 3, or more air knives and 4, 6, 8, 10, 100, etc. external flow inlets. Moreover, the embodiments of the air flow system 100 shown in FIGS. 1 and 3 can be combined in a single air flow system (not separately illustrated).

In some embodiments, the air knife 302 is configured to deliver a continuous volume of air flow 306 across a laser beam 308 above a surface of a work piece 310. In some embodiments, the air flow 306 from the air knife 302 is not regulated (as shown), although in other embodiments the air knife 302 can be configured with an internal valve (not separately shown) to regulate the air flow 306.

In some embodiments, one or more of the external flow inlets 304a, 304b is configured with an internal valve (as shown, the two internal valves 110a, 110b for the external flow inlets 304a, 304b, respectively). Each of the internal valves 110a, 110b can be individually actuated (or otherwise positioned) within the external flow inlets 304a, 304b to regulate air flow 312 in a similar manner as described with respect to FIG. 1.

In some embodiments, each of the internal valves 110a, 110b can be opened or closed to any degree (i.e., between and including a fully open and a fully closed state) to finely tune the air flow through the external flow inlets 304a, 304b. Advantageously, the internal valves 110a, 110b can be opened or closed to different degrees. For example, the internal valve 110a can be partially open while the internal valve 110b can be fully closed (as shown). In another example, the internal valve 110a can be 15 percent open while the internal valve 110b can be 95 percent open (or fully open, or 3 percent open, etc., not separately shown).

The air flow system 100 shown in FIG. 3 can include a controller 112 communicatively coupled to an air flow monitor (not separately shown) and configured with valve control logic (see, e.g., FIG. 2) to adjust a position of one or more valves (e.g., one or both of the internal valves 110a, 110b) based on the signal “A” and the valve control logic, in a similar manner as discussed previously with respect to FIG. 1. In some embodiments, the controller 112 is configured to send a valve control signal (“V P” in FIG. 3) to one or more of the external flow inlets 304a, 304b to change a position (actuate or otherwise adjust) of one or more of the internal valves 110a, 110b.

In some embodiments, the air flow system 100 includes a weld beam adjuster 314. The weld beam adjuster 314 can be configured to adjust an angle of the laser beam 308 terminating at a beam spot on a work piece. In other words, the weld beam adjuster 314 can be configured to reposition a weld location (i.e., reposition the beam spot) on the work piece 310. In some embodiments, the weld beam adjuster 314 is coupled to an emitter (not separately shown) of the laser beam 308. In some embodiments, the controller 112 is configured to adjust, via the weld beam adjuster 314, the angle of the laser beam 308 based on an air flow mapping (e.g., the signal “A” discussed previously) to increase an average air flow velocity along the laser beam 308.

FIG. 4A illustrates a horizontal air flow mapping 400 for an air flow system 100 configured in accordance with one or more embodiments. FIG. 4B illustrates the horizontal air flow mapping 400 for the air flow system 100 after adjusting one or more internal valves of the air flow system 100 in accordance with one or more embodiments. FIG. 4C depicts a legend for the horizontal air flow mappings of FIGS. 4A and 4B in accordance with one or more embodiments.

With respect to FIG. 4A, the horizontal air flow mapping 400 depicts the average air flow velocity (shaded) for a horizontal cross-section of air as a function of location. As shown, the X-axis depicts a first distance “D” along a first direction from a reference point “0” and the Y-axis depicts a second distance “H” along a second direction from the reference point “0”, where the second direction is perpendicular to the first direction. The reference point can be arbitrarily defined, and may include, for example, an edge or a surface of a work piece (e.g., the work piece 310) or a fixed point independent of the work piece.

As shown in FIG. 4A, the horizontal air flow mapping 400 includes regions 402 having a relatively high average air flow velocity, regions 404 having a relatively low average air flow velocity, and one or more additional regions (not separately indicated) having a variety of intermediate average air flow velocities. Observe that the average air flow velocities are somewhat symmetrical. Consider, for example, a diagonal line (not separately indicated) that extends from the top-left to the bottom-right of the horizontal air flow mapping 400. Such an air velocity mapping can be expected when the internal valves 110a, 110b of the air flow system 100 (FIG. 1 or FIG. 3) are configured to deliver roughly equivalent volumes of air. As further shown in FIG. 4A, in some embodiments, a beam spot 406 (e.g., the location of the focus of the laser beam 308 on the work piece 310) lies in one of the regions 404 having a relatively low average air flow velocity.

With respect to FIG. 4B, observe that the average air flow velocities are now asymmetrical. For example, regions 402 having a relatively high average air flow velocity are now confined to one side of the horizontal air flow mapping 400. Observe further that, advantageously, regulating the air flow to an asymmetric state in this manner has resulted in an increase in average air flow velocity at the beam spot 406. Such an air velocity mapping can be provided by adjusting the internal valves 110a, 110b of the air flow system 100 (FIG. 1 or FIG. 3) to deliver different volumes of air. It should be understood that a range of possible air flow mappings can be provided by changing the relative positions of the internal valves 110a, 110b. In some embodiments, air flow mappings for a plurality of actuation states of the internal valves 110a, 110b are determined and a configuration having a desirable air flow mapping (e.g., highest air flow at the beam spot, highest average air flow in the air column above the beam spot, etc.) is selected for a welding operation.

FIG. 5A illustrates a vertical air flow mapping 500 for an air flow system 100 configured in accordance with one or more embodiments. FIG. 5B illustrates the vertical air flow mapping 500 for the air flow system 100 when space or fixturing is limited in accordance with one or more embodiments. FIG. 5C depicts a legend for the vertical air flow mappings of FIGS. 5A and 5B in accordance with one or more embodiments.

With respect to FIG. 5A, the vertical air flow mapping 500 depicts the average air flow velocity (shaded) for a vertical cross-section of air as a function of location. As shown, the X-axis depicts a distance “D” along a first direction from a reference point “0” and the Y-axis depicts a height along a second direction “H” above the reference point “0”, where the second direction is orthogonal to the first direction. The reference point can be arbitrarily defined, and may include, for example, an edge or a surface of a work piece (e.g., the work piece 310) or a fixed point independent of the work piece.

As shown in FIG. 5A, the vertical air flow mapping 500 includes regions 402 having a relatively high average air flow velocity, regions 404 having a relatively low average air flow velocity, and one or more additional regions (not separately indicated) having a variety of intermediate average air flow velocities. Observe that an initial location for the beam spot 406 lies in one of the regions 404 having a relatively low average air flow velocity. Observe further that a laser beam 502 terminating at the beam spot 406 passes through an air column of intermediate and low average air flow velocities.

Advantageously, in some embodiments, the position (orientation, emission angle, etc.) of the laser beam 502 can be adjusted to increase the average air flow velocity in the air column above the beam spot 406 through which the laser beam 502 passes. In some embodiments, the air flow system 100 includes a weld beam adjuster (e.g., the weld beam adjuster 314) configured to adjust an angle of the laser beam 502. In some embodiments, such as for welding applications having unlimited (or effectively unlimited) space or flexible fixturing, the region 504 of possible beam angles is relatively large (or even completely unobstructed). Observe that changing the position of the laser beam 502 (and, consequently, the location of the beam spot 406) results in an increase in average air flow velocity in the air column above the beam spot 406.

With respect to FIG. 5B, in contrast to the vertical air flow mapping 500 shown in FIG. 5A, the vertical air flow mapping 500 of FIG. 5B includes one or more knockout regions 506 (also referred to as restricted regions). The knockout regions 506 can result from spacing and/or fixturing limitations unique to a particular welding application and represents positional limitations for the laser beam 502.

Advantageously, in some embodiments, the position (orientation, emission angle, etc.) of the laser beam 502 can be adjusted within the positional limits defined by the knockout regions 506 to increase the average air flow velocity in the air column above the beam spot 406 as much as possible. Observe, for example, the skew of the laser beam 502 of FIG. 5B towards a region 508 of relatively higher average air flow velocities.

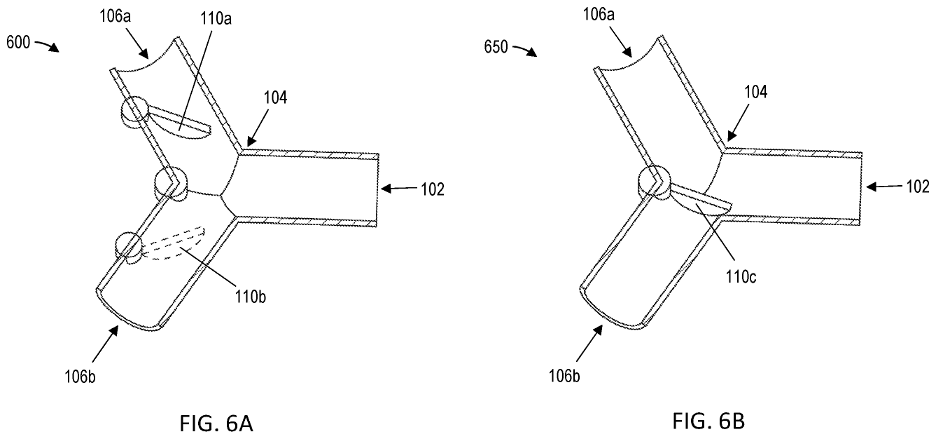

FIG. 6A illustrates a cross-sectional view of a portion 600 of an air flow system 100 in accordance with one or more embodiments. As shown in FIG. 6A, the portion 600 of the air flow system 100 includes a primary inlet 102, a splitter 104, and two secondary inlets 106a, 106b, configured and arranged in a similar manner as discussed previously.

In some embodiments, the portion 600 of an air flow system 100 includes an internal valve positioned within one or more of the secondary inlets 106a, 106b (as shown, the internal valve 110a and an optional internal valve 110b for the secondary inlets 106a, 106b, respectively). In some embodiments, the two internal valves 110a, 110b can be separately and independently actuated to any degree (i.e., to any state between fully open and fully closed) to regulate air through the air flow system 100.

FIG. 6B illustrates a cross-sectional view of a portion 650 of an air flow system 100 in accordance with one or more embodiments. The portion 650 depicts an alternative configuration from that shown in FIG. 6A. As shown in FIG. 6B, the portion 650 of the air flow system 100 includes a primary inlet 102, a splitter 104, and two secondary inlets 106a, 106b, configured and arranged in a similar manner as discussed previously.

In some embodiments, the portion 650 of an air flow system 100 includes an internal valve 110c positioned at the splitter 104. In some embodiments, the internal valve 110c can be actuated to any degree (i.e., to any state between fully open and fully closed from the perspective of one side of the secondary inlets 106a, 106b) to regulate the relative distribution of air through the secondary inlets 106a, 106b. While shown separately for ease of discussion and illustration, is should be understood that the portion 600 shown in FIG. 6A and the portion 650 shown in FIG. 6B can be combined in a single implementation (not separately shown) as desired.

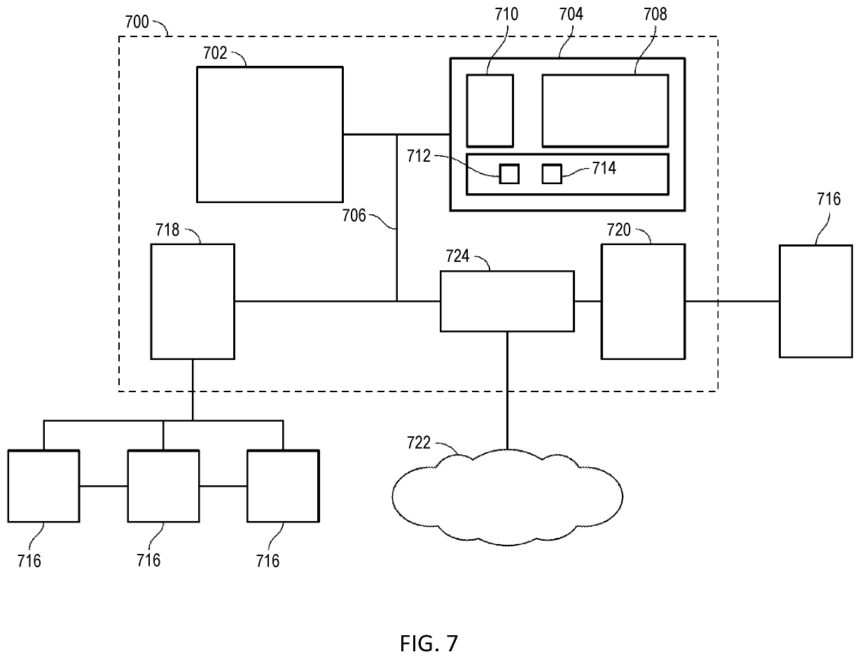

FIG. 7 illustrates aspects of an embodiment of a computer system 700 that can perform various aspects of embodiments described herein. In some embodiments, the computer system 700 can be incorporated within or in combination with an air flow system (e.g., the air flow system 100). The computer system 700 includes at least one processing device 702, which generally includes one or more processors (e.g., the controller 112 of FIG. 1) for performing a variety of functions, such as, for example, controlling the actuation states of one or more valves (e.g., the valves 110a, 110b of FIG. 1). More specifically, the computer system 700 can include valve control logic 200 (as shown, e.g., in FIG. 2) necessary to initiate air flow regulation measures by adjusting the actuation states of one or more valves of the air flow system.

Components of the computer system 700 include the processing device 702 (such as one or more processors or processing units), a system memory 704, and a bus 706 that couples various system components including the system memory 704 to the processing device 702. The system memory 704 may include a variety of computer system readable media. Such media can be any available media that is accessible by the processing device 702, and includes both volatile and non-volatile media, and removable and non-removable media.

For example, the system memory 704 includes a non-volatile memory 708 such as a hard drive, and may also include a volatile memory 710, such as random access memory (RAM) and/or cache memory. The computer system 700 can further include other removable/non-removable, volatile/non-volatile computer system storage media.

The system memory 704 can include at least one program product having a set (e.g., at least one) of program modules that are configured to carry out functions of the embodiments described herein. For example, the system memory 704 stores various program modules that generally carry out the functions and/or methodologies of embodiments described herein. A module or modules 712, 714 may be included to perform functions related to control of the air flow system 100, such as, for example, determine an air flow mapping, changing an actuation state of a valve, etc. The computer system 700 is not so limited, as other modules may be included depending on the desired functionality of the respective system. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. For example, the module(s) can be configured via software, hardware, and/or firmware to maintain a target air flowrate at or above a work piece during a laser welding application according to one or more embodiments.

The processing device 702 can also be configured to communicate with one or more external devices 716 such as, for example, a keyboard, a pointing device, and/or any devices (e.g., a network card, a modem, etc.) that enable the processing device 702 to communicate with one or more other computing devices. Communication with various devices can occur via Input/Output (I/O) interfaces 718 and 720.

The processing device 702 may also communicate with one or more networks 722 such as a local area network (LAN), a general wide area network (WAN), a bus network and/or a public network (e.g., the Internet) via a network adapter 724. In some embodiments, the network adapter 724 is or includes an optical network adaptor for communication over an optical network. It should be understood that although not shown, other hardware and/or software components may be used in conjunction with the computer system 700. Examples include, but are not limited to, microcode, device drivers, redundant processing units, external disk drive arrays, RAID systems, and data archival storage systems, etc.

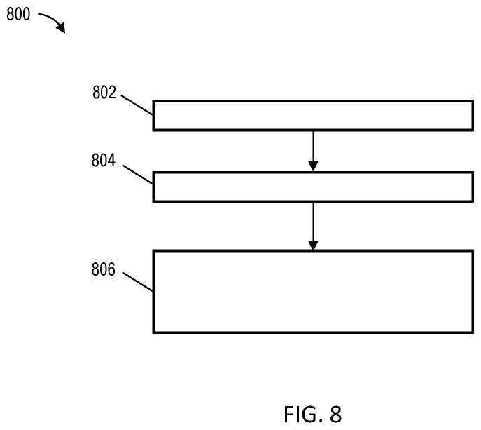

Referring now to FIG. 8, a flowchart 800 for leveraging an air flow system to improve weld quality and efficiency is generally shown according to an embodiment. The flowchart 800 is described in reference to FIGS. 1 to 7 and may include additional steps not depicted in FIG. 8. Although depicted in a particular order, the blocks depicted in FIG. 8 can be rearranged, subdivided, and/or combined.

At block 802, an air flow system is provided. In some embodiments, the air flow system includes a primary inlet coupled to an air source and one or more secondary inlets coupled to the primary inlet. In some embodiments, at least one of the one or more secondary inlets includes an internal valve. Each internal valve is actuatable between a fully open state, a fully closed state, and an intermediate state. The air flow system can further include an outlet coupled to each of the one or more secondary inlets downstream of the internal valve. The air flow system can further include a controller configured to adjust a position of each internal valve.

In some embodiments, the air flow system includes two secondary inlets coupled to the primary inlet via a splitter. In some embodiments, an internal valve is positioned in the splitter. In some embodiments, each of the one or more secondary inlets includes an internal valve.

At block 804, an air flow mapping is generated. In some embodiments, the air flow system further includes an air monitoring system configured to generate the air flow mapping. In some embodiments, the air monitoring system includes a particle image velocimetry (PIV) system.

At block 806, the controller adjusts the position of each internal valve. In some embodiments, the controller adjusts the position of each internal valve based on the air flow mapping to increase an average air flow velocity at a beam spot of a welding laser. In some embodiments, the controller is configured to adjust a position of each internal valve based in part on a weld plume observation.

In some embodiments, the air flow system further includes a weld beam adjuster coupled to the welding laser. In some embodiments, the weld beam adjuster is configured to adjust an angle of a laser beam (within, e.g., the physical limitations and constraints of the air flow system) terminating at the beam spot of the welding laser. In some embodiments, the controller is further configured to adjust, via the weld beam adjuster, the angle of the laser beam based on the air flow mapping to increase an average air flow velocity along the laser beam.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An air flow system for welding applications, the air flow system comprising:
a primary inlet coupled to an air source;
one or more secondary inlets coupled to the primary inlet, wherein at least one of the one or more secondary inlets comprises an internal valve, each internal valve actuatable between a fully open state, a fully closed state, and an intermediate state;
an outlet coupled to each of the one or more secondary inlets downstream of the internal valve; and
a controller configured to adjust a position of each internal valve, wherein the controller is configured to adjust the position of each internal valve based on an air flow mapping to increase an average air flow velocity at a beam spot of a welding laser.

2. The air flow system of claim 1, wherein the air flow system comprises two secondary inlets coupled to the primary inlet via a splitter.

3. The air flow system of claim 2, wherein an internal valve is positioned in the splitter.

4. The air flow system of claim 1, wherein each of the one or more secondary inlets comprises an internal valve.

5. The air flow system of claim 1, wherein the air flow system further comprises an air monitoring system.

6. The air flow system of claim 5, wherein the air monitoring system comprises a particle image velocimetry (PIV) system configured to generate the air flow mapping.

7. The air flow system of claim 1, wherein the controller is configured to adjust a position of each internal valve based in part on a weld plume observation.

8. The air flow system of claim 1, further comprising a weld beam adjuster coupled to the welding laser.

9. The air flow system of claim 8, wherein the weld beam adjuster is configured to adjust an angle of a laser beam terminating at the beam spot of the welding laser.

10. The air flow system of claim 9, wherein the controller is further configured to adjust, via the weld beam adjuster, the angle of the laser beam based on the air flow mapping to increase an average air flow velocity along the laser beam.

11. A method comprising:
providing an air flow system comprising:
a primary inlet coupled to an air source;
one or more secondary inlets coupled to the primary inlet, wherein at least one of the one or more secondary inlets comprises an internal valve, each internal valve actuatable between a fully open state, a fully closed state, and an intermediate state;
an outlet coupled to each of the one or more secondary inlets downstream of the internal valve; and
a controller configured to adjust a position of each internal valve;
generating an air flow mapping; and
adjusting, via the controller, the position of each internal valve based on the air flow mapping to increase an average air flow velocity at a beam spot of a welding laser.

12. The method of claim 11, wherein the air flow system further comprises two secondary inlets coupled to the primary inlet via a splitter.

13. The method of claim 12, wherein an internal valve is positioned in the splitter.

14. The method of claim 11, wherein each of the one or more secondary inlets comprises an internal valve.

15. The method of claim 11, wherein the air flow system further comprises an air monitoring system.

16. The method of claim 15, wherein the air monitoring system comprises a particle image velocimetry (PIV) system configured to generate the air flow mapping.

17. The method of claim 11, wherein the controller is configured to adjust a position of each internal valve based in part on a weld plume observation.

18. The method of claim 11, wherein the air flow system further comprises a weld beam adjuster coupled to the welding laser.

19. The method of claim 18, wherein the weld beam adjuster is configured to adjust an angle of a laser beam terminating at the beam spot of the welding laser.

20. The method of claim 19, wherein the controller is further configured to adjust, via the weld beam adjuster, the angle of the laser beam based on the air flow mapping to increase an average air flow velocity along the laser beam.
